(19) United States
(12) Patent Application Publication
(10) Pub. No.: US 2018/0026764 A1
(43) Pub. Date: Jan. 25, 2018

(54) METHOD OF MAPPING TRANSMISSION LAYERS TO FREQUENCY DIVISION MULTIPLEXED DEMODULATION REFERENCE SIGNAL PORTS

(71) Applicant: QUALCOMM Incorporated, San Diego, CA (US)

(72) Inventors: June NAMGOONG, San Diego, CA (US); Jing JIANG, San Diego, CA (US); Alexandros MANOLAKOS, San Diego, CA (US); Krishna Kiran MUKKAVILLI, San Diego, CA (US); Joseph Binamira SORIAGA, San Diego, CA (US); Tingfang JI, San Diego, CA (US)

(21) Appl. No.: 15/272,783

(22) Filed: Sep. 22, 2016

Related U.S. Application Data
(60) Provisional application No. 62/366,289, filed on Jul. 25, 2016.

(51) Int. Cl. H04L 5/00; H04B 7/04; H04L 25/02

(52) U.S. Cl. CPC H04L 5/0048; H04L 25/0224; H04B 7/04; H04L 5/0098

(57) ABSTRACT

A method for mapping transmission layers to demodulation reference signal (DMRS) antenna ports may include: determining a number of transmission layers to be transmitted; sorting a plurality of DMRS antenna ports in ascending order based on a channel estimation mean square error (MSE); and assigning the number of transmission layers to the plurality of DMRS antenna ports in ascending order of the channel estimation MSE.

### CROSS-REFERENCE TO RELATED APPLICATION(S)

This application claims the benefit of U.S. Provisional Application No. 62/366,289, filed Jul. 25, 2016 (Atty. Docket No. 116418-696PV1), the disclosure of which is incorporated herein in its entirety by reference.

### BACKGROUND

When demodulation reference signals (DMRSs) for more than two antenna ports are frequency division multiplexed in a comb fashion as in interleaved frequency division multiple access (IFDMA), the channel estimation performance is different for each antenna port. In the following, the set of DMRS tones for an antenna port will be referred to as “DMRS port” for the antenna port. Hence, each “DMRS port” is associated with a DMRS antenna port, on which it is transmitted. A “comb” may be defined as the pattern formed by the interleaved tones on which the DMRS for one DMRS antenna port (i.e., a DMRS port) are transmitted. In particular, the DMRS port on the comb with the large worst-case distance from the band edges is subject to large band-edge effects in terms of the channel estimation that negatively affect performance.

When a multiple-input multiple-output (MIMO) channel has medium to high correlation between the mobile communication device antennas and the evolved node B (eNB) antennas, the optimum transmission rank tends to be small. Accordingly, if the DMRS antenna ports chosen by the eNB for the transmission layers have higher channel estimation mean square error (MSE) than the other DMRS antenna ports, the throughput performance with the DMRS antenna ports having the higher channel estimation MSE will be suboptimal.

### SUMMARY

Apparatuses and methods for mapping transmission layers to DMRS antenna ports are provided.

According to various aspects there is provided a method for mapping transmission layers to demodulation reference signal (DMRS) antenna ports. In some aspects, the method may include: determining a number of transmission layers to be transmitted; sorting a plurality of DMRS antenna ports in ascending order based on channel estimation mean square error (MSE); and assigning transmission layers to the plurality of DMRS antenna ports in ascending order of the channel estimation MSE

According to various aspects there is provided a method for mapping mobile communication devices to demodulation reference signal (DMRS) antenna ports. In some aspects, the method may include: determining a number of mobile communication devices to be assigned to a plurality of DMRS antenna ports; sorting the plurality of DMRS antenna ports in ascending order based on channel estimation mean square error (MSE); sorting the number of mobile communication devices in descending order of downlink (DL) spectral efficiency (SE); and assigning the number of mobile communication devices to the plurality of DMRS antenna ports in descending order of DL SE and ascending order of the channel estimation MSE.

According to various aspects there is provided a non-transitory computer readable medium. In some aspects, the non-transitory computer readable medium may include instructions for causing one or more processors to perform operations including: determining a number of mobile communication devices to be assigned to the DMRS antenna ports; sorting a plurality of DMRS antenna ports in ascending order based on channel estimation mean square error (MSE); sorting the number of mobile communication devices in descending order of downlink (DL) spectral efficiency (SE); and assigning the number of mobile communication devices to the plurality of DMRS antenna ports in descending order of DL SE and ascending order of the channel estimation MSE.

According to various aspects there is provided an apparatus for mapping transmission layers to demodulation reference signal (DMRS) antenna ports. In some aspects, the apparatus may include: means for determining a number of transmission layers to be transmitted; means for sorting a plurality of DMRS antenna ports in ascending order based on a channel estimation mean square error (MSE); and means for assigning the number of transmission layers to the plurality of DMRS antenna ports in ascending order of the channel estimation MSE.

According to various aspects there is provided an apparatus for mapping mobile communication devices to demodulation reference signal (DMRS) antenna ports. In some aspects, the apparatus may include: means for determining a number of the mobile communication devices to be assigned to a plurality of DMRS antenna ports; means for sorting the plurality of DMRS antenna ports in ascending order based on a channel estimation mean square error (MSE); means for sorting the number of the mobile communication devices in descending order of a downlink (DL) spectral efficiency (SE); and means for assigning the number of the mobile communication devices to the plurality of DMRS antenna ports in descending order of the DL SE and ascending order of the channel estimation MSE.

Other features and advantages should be apparent from the following description which illustrates by way of example aspects of the various teachings of the disclosure.

### BRIEF DESCRIPTION OF THE DRAWINGS

Aspects and features of the various embodiments will be more apparent by describing examples with reference to the accompanying drawings, in which:

FIG. 1A is a block diagram illustrating a mobile communication device in accordance with certain aspects of the present disclosure;

FIG. 1B is a diagram illustrating a network environment in accordance with certain aspects of the present disclosure;

FIG. 2A is a diagram illustrating SU-MIMO;

FIG. 2B is a diagram illustrating MU-MIMO;

FIG. 2C is a diagram illustrating an example multiple access wireless communication system in accordance with certain aspects of the present disclosure;

FIG. 3A is a diagram illustrating an example of a resource block showing frequency division multiplexing of first through second set of DMRS tones for first through second DMRS antenna ports, respectively;

FIG. 3B is a diagram illustrating an example of a resource block showing frequency division multiplexing of first through fourth set of DMRS tones for first through fourth DMRS antenna ports, respectively, in accordance with certain aspects of the present disclosure;

FIG. 4 is a graph illustrating a comparison of transmission layer to DMRS mapping for four DMRS antenna ports in accordance with certain aspects of the present disclosure;

FIG. 5 is a graph illustrating a comparison of transmission layer to DMRS mapping for four DMRS antenna ports with physical resource block (PRB) bundling in accordance with certain aspects of the present disclosure;

FIG. 6A is a flowchart illustrating a method for mapping transmission layers to DMRS antenna ports for a SU-MIMO in accordance with certain aspects of the present disclosure;

FIG. 6B is a flowchart illustrating a method for assigning transmission layers to DMRS antenna ports in accordance with certain aspects of the present disclosure;

FIG. 7A is a flowchart illustrating a method 700 for mapping mobile communication devices to DMRS antenna ports for a MU-MIMO transmission scheme in accordance with certain aspects of the present disclosure;

FIG. 7B is a flowchart illustrating a method for assigning mobile communication devices to DMRS antenna ports in accordance with certain aspects of the present disclosure;

FIG. 8 is a diagram illustrating an example of mapping DMRSs for four antenna ports to resource elements on four combs of a resource block in accordance with certain aspects of the present disclosure;

FIG. 9 is a diagram illustrating an example of mapping DMRSs for eight antenna ports to resource elements on four combs of a resource block in accordance with certain aspects of the present disclosure

FIGS. 10A and 10B are diagrams illustrating alternate example mappings of DMRSs for eight antenna ports to resource elements on four combs of a resource block in accordance with certain aspects of the present disclosure;

FIG. 11 is a diagram illustrating an example of mapping DMRSs for eight antenna ports to resource elements on eight combs of a resource block 1100 in accordance with certain aspects of the present disclosure;

FIGS. 12A and 12B are diagrams illustrating alternate example mappings of DMRSs for eight antenna ports to resource elements on eight combs of a resource block in accordance with certain aspects of the present disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

Appendix I attached hereto forms part of this disclosure and is incorporated herein in its entirety by reference.

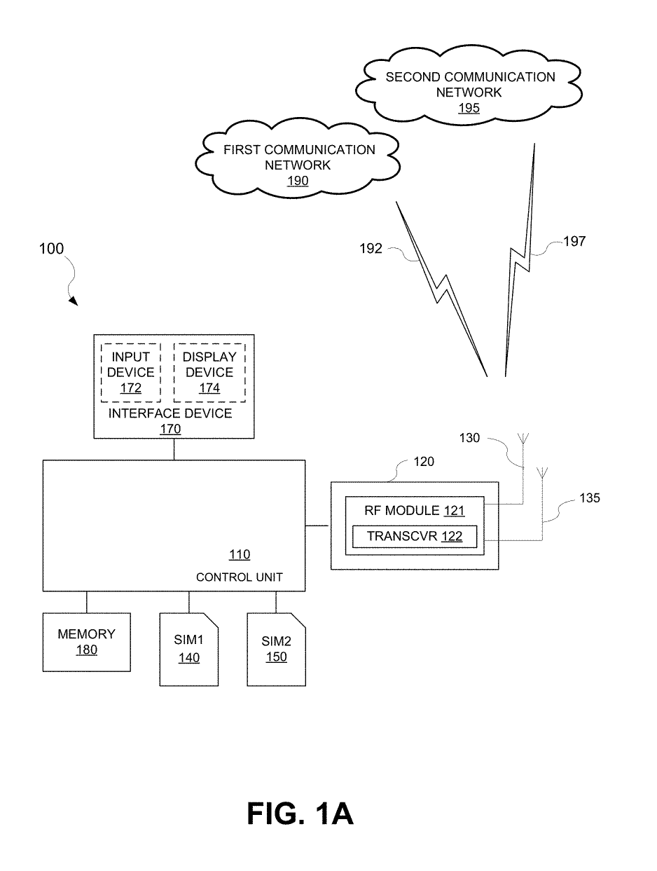

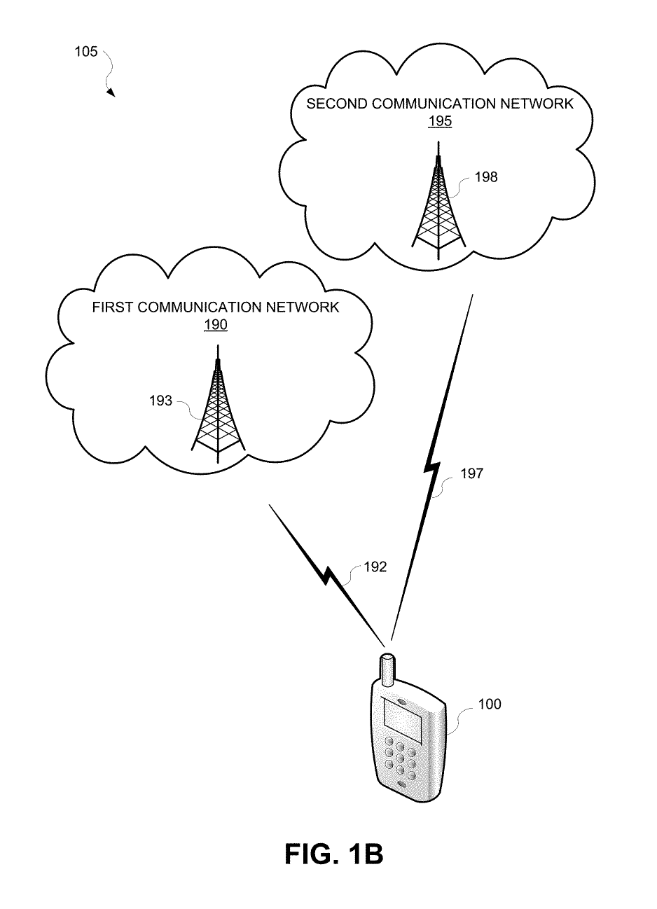

FIG. 1A is a block diagram illustrating a mobile communication device 100 in accordance with certain aspects of the present disclosure. As illustrated in FIG. 1A, the mobile communication device 100 may include a control unit 110, a communication unit 120, a first antenna 130, a second antenna 135, a first subscriber identity module (SIM) 140, a second SIM 150, a user interface device 170, and a memory 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more communication units and may interface with one or more antennas without departing from the scope of protection.

The communication unit 120 may include, for example, but not limited to, an RF module 121. The RF module 121 may include, for example, but not limited to a transceiver 122. One of ordinary skill in the art will appreciate that embodiments of the mobile communication device 100 may include more than one communication unit and/or more than one antenna without departing from the scope of protection.

A SIM (for example the first SIM 140 and/or the second SIM 150) in various embodiments may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the communication unit 120 with a first subscription (Sub1) 192 associated with a first radio access technology (RAT) on a first communication network 190 and the second SIM 150 may associate the communication unit 120 with a second subscription (Sub2) 197 associated with a second RAT on a second communication network 195. When a RAT is active, the communication unit 120 receives and transmits signals on the active RAT. When a RAT is idle, the communication unit 120 receives but does not transmit signals on the idle RAT.

For convenience, the various embodiments are described in terms of DSDS mobile communication devices. However, one of ordinary skill in the art will appreciate that the various embodiments may be extended to single SIM, Multi-SIM Multi-Standby (MSMS), and/or Multi-SIM Multi-Active (MSMA) mobile communication devices without departing from the scope of protection.

The first communication network 190 and the second communication network 195 may be operated by the same or different service providers, and/or may support the same or different RATs, for example, but not limited to, GSM, CDMA, wideband CDMA (WCDMA), and long term evolution (LTE).

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various embodiments.

The control unit 110 may be configured to control overall operation of the mobile communication device 100 including control of the communication unit 120, the user interface device 170, and the memory 180. The control unit 110 may be a programmable device, for example, but not limited to, a microprocessor (e.g., general-purpose processor, baseband modem processor, etc.) or microcontroller.

The memory 180 may be configured to store operating systems and/or application programs for operation of the mobile communication device 100 that are executed by the control unit 110, as well as to store application data and user data.

FIG. 1B is a diagram illustrating a network environment 105 in accordance with certain aspects of the present disclosure. Referring to FIGS. 1A and 1B, a mobile communication device 100 may be configured to communicate with a first communication network 190 on a first subscription 192 and a second communication network 195 on a second subscription 197. One of ordinary skill in the art will appreciate that the mobile communication device may configured to communicate with more than two communication networks and may communicate on more than two subscriptions without departing from the scope of protection.

The first communication network 190 and the second communication network 195 may implement the same or different radio access technologies (RATs). For example, the first communication network 190 may be a GSM network and the first subscription 192 may be a GSM subscription. The second communication network 195 may also be a GSM network. Alternatively, the second communication network 195 may implement another RAT including, for example, but not limited to, LTE, WCDMA, and Time Division-Synchronous Code Division Multiple Access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various embodiments.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

A MIMO system may include of a plurality of transmit antennas and a plurality of receive antennas. By using the same channel, every antenna receives not only the direct components intended for it, but also the indirect components intended for the other antennas. Data to be transmitted may be divided into independent data streams. The number of streams is less than or equal to the number of antennas. Spectral efficiency (SE) may be controlled by an eNB (for example, the first BTS 193 and/or the second BTS 198) dependent upon a link condition. The eNB may also determine the number of data streams to be used for parallel transmission dependent upon for example, but not limited to channel estimation MSE.

During downlink (DL) MIMO transmission, an evolved NodeB (eNB) (for example, the first BTS 193 and/or the second BTS 198) will assign each scheduled mobile communication device (e.g., the mobile communication device 100) with a specific number of parallel data streams (i.e., transmission layers) dependent upon a channel condition. Note that the terms transmission layer and data stream may be used interchangeably throughout this disclosure. The maximum number of parallel streams is given by the lowest of the number of receive and transmit antenna. For example, 4×2 MIMO, 2×2 MIMO and 2×4 MIMO may transfer a maximum of 2 parallel streams of data.

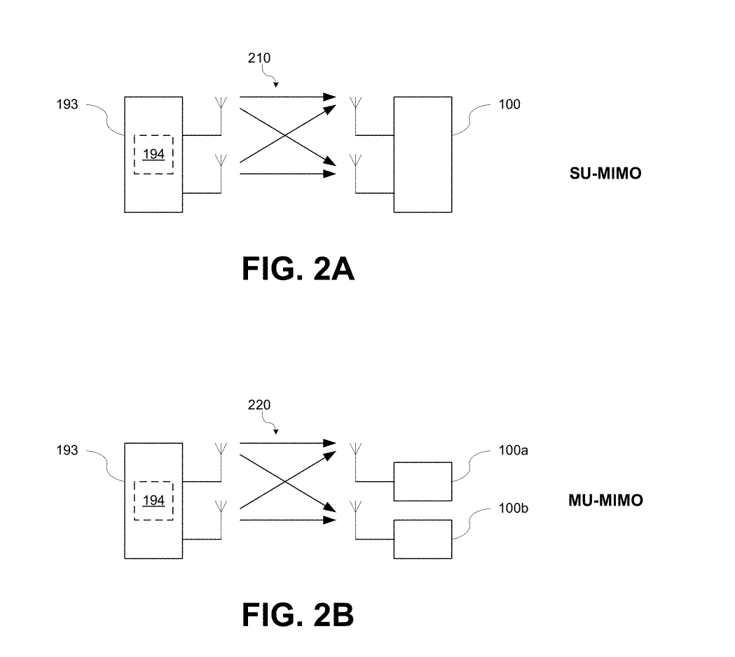

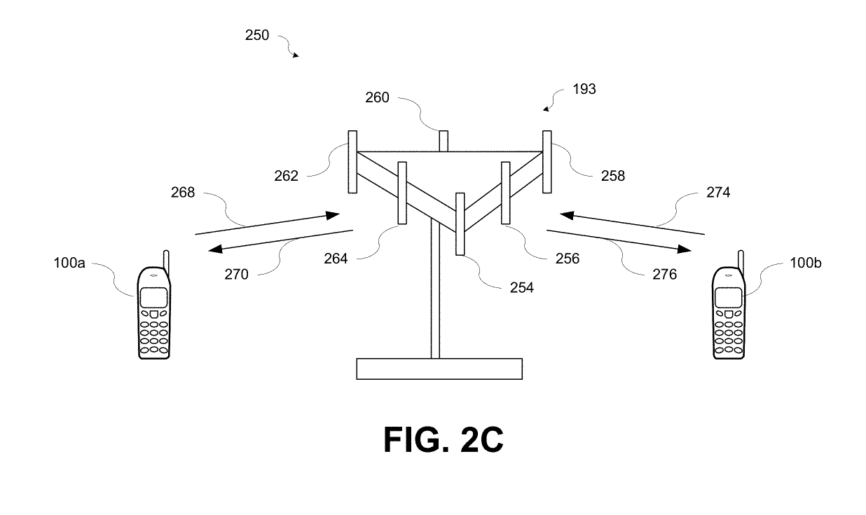

When the data rate is to be increased for a single mobile communication device, this is called Single User MIMO (SU-MIMO). FIG. 2A is a diagram illustrating SU-MIMO. Referring to FIG. 2A, an eNB, for example, the first BTS 193 and/or the second BTS 198, may include a controller 194. The controller 194 may be configured to control overall operation of the eNB 193. The controller 194 may be a programmable device, for example, but not limited to, one or more microprocessors (e.g., general-purpose processors, microcontrollers, and/or computers. The controller 194 may control the eNB 193 to transmit a plurality of data streams 210 to a mobile communication device (e.g., the mobile communication device 100).

When the individual data streams are assigned to various mobile communication devices, this is called Multi-User MIMO (MU-MIMO). FIG. 2B is a diagram illustrating MU-MIMO. With Multi-User MIMO, the eNB allocates the same time and frequency resources to more than one mobile communication device. A different Orthogonal Covering Code (OCC) is allocated to multiplex and differentiate between each mobile communication device's DMRS in release 10 of the 3GPP specification.

Referring to FIG. 2B, the controller 194 may control the eNB 193 to transmit a plurality of data streams 220 to each of a plurality of mobile communication devices (e.g., a first mobile communication device 100a and a second mobile communication device 100b) one of ordinary skill in the art will appreciate that the eNB 193 may communicate with more than two mobile communication devices without departing from the scope of the disclosure.

FIG. 2C is a diagram illustrating an example multiple access wireless communication system 250 in accordance with certain aspects of the present disclosure. Referring to FIG. 2C, in an aspect of the present disclosure, the wireless communication system may be a wireless mobile broadband system based on Orthogonal Frequency Division Multiplexing (OFDM). An eNB 193 may include multiple antenna groups, one group including antennas 254 and 256, another group including antennas 258 and 260, and an additional group including antennas 262 and 264. In FIG. 2C, two antennas are shown for each antenna group, however, more or fewer antennas may be utilized for each antenna group.

The first mobile communication device 100a may be in communication with antennas 262 and 264, where antennas 262 and 264 transmit information to the first mobile communication device 100a over downlink 270 and receive information from the first mobile communication device 100a over uplink 268. The second mobile communication device 100b may be in communication with antennas 256 and 258, where antennas 256 and 258 transmit information to the second mobile communication device 100b over downlink 276 and receive information from the second mobile communication device 100b over uplink 274. In a frequency division duplex (FDD) system, communication links 268, 270, 274 and 276 may use different frequency for communication. For example, downlink 270 may use a different frequency then that used by uplink 268.

Various example embodiments provide a method of mapping transmission layers (i.e., data streams) to DMRS antenna ports to improve the DL data throughput. An antenna port on which the DMRS is transmitted may be mapped to more than one physical antenna. The DMRSs for multiple transmission layers may be multiplexed by frequency-division multiplexing (FDM) in a comb fashion, for example, as in interleaved frequency division multiple access (IFDMA), where the number of combs is greater than two. (If DMRS multiplexing is only achieved by FDM, the number of combs is the same as the maximum number of DMRS antenna ports.) The set of DMRS tones for an antenna port is referred to as a “DMRS port.” Hence, each “DMRS port” is associated with a DMRS antenna port on which it is transmitted. A DMRS may be used to demodulate each data stream associated with the DMRS. This allows the mobile communication device to estimate the channel for each transmission layer.

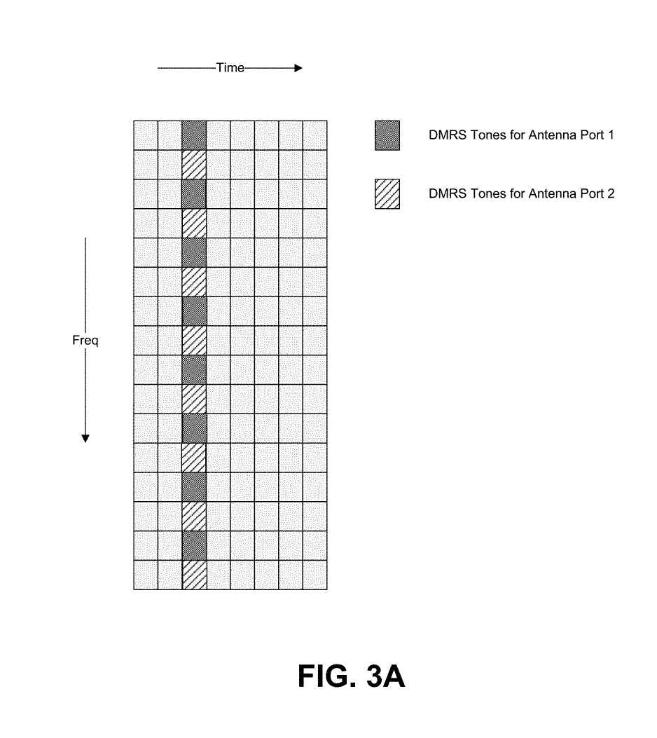

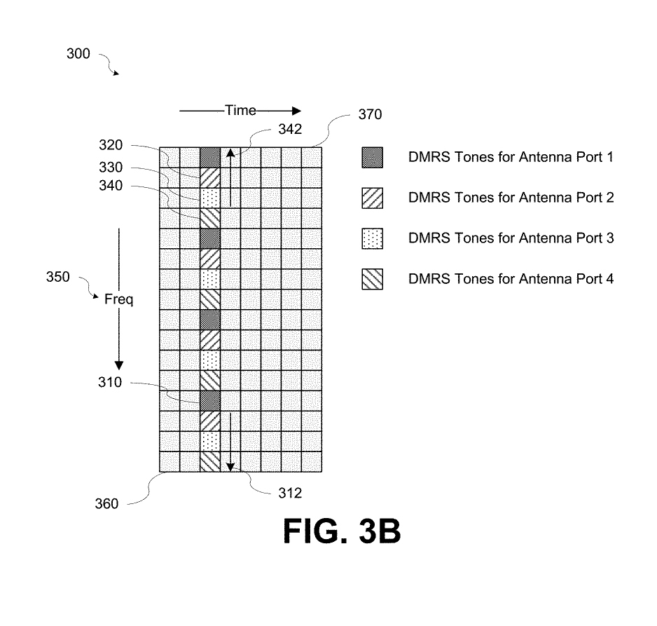

FIG. 3A is a diagram illustrating an example of a resource block showing frequency division multiplexing of first through second set of DMRS tones for first through second DMRS antenna ports, respectively. FIG. 3A shows a DMRS multiplexing scheme using two DMRS antenna ports, port′ (solid) and port 2 (cross-hatched). Each grid represents a resource element which represents one tone by one OFDM symbol. DMRS of port 1 is frequency multiplexed with the DMRS of port 2 in a comb fashion, one comb for each port. In one example, each of the two DMRS antenna ports has DMRS tones that are uniformly spaced in frequency with the frequency spacing of two subcarriers. The DMRS patterns for port 1 and port 2 are mirror images of each other in the frequency domain so the channel estimation quality achieved at a mobile communication device for antenna port 1 will be the same as for antenna port 2. So whether a data stream is assigned to the DMRS antenna port 1 or the DMRS antenna port 2 will not affect its demodulation performance.

FIG. 3B is a diagram illustrating an example of a resource block 300 showing frequency division multiplexing of first through fourth set of DMRS tones 310, 320, 330, 340, respectively, for DMRS antenna ports one through four, respectively, in accordance with certain aspects of the present disclosure. The first set of DMRS tones 310 for DMRS antenna port 1 is referred to as “DMRS port 1.” The second set of DMRS tones 320 for DMRS antenna port 2 is referred to as “DMRS port 2.” The third set of DMRS tones 330 for DMRS antenna port 3 is referred to as “DMRS port 3.” The fourth set of DMRS tones 340 for DMRS antenna port 4 is referred to as “DMRS port 4”. The DMRS tones may be generated at predetermined subcarrier frequencies.

Referring to FIG. 3B, the DMRSs are pilot tones for the respective DMRS antenna ports. The DMRS tones are used by the mobile communication device to estimate the channel at the frequencies in between the pilot tones for the respective DMRS antenna ports since PDSCH associated with each DMRS antenna port receives data on all of the subcarrier frequencies. The subcarriers for each DMRS antenna port may be uniformly spaced in frequency (e.g., spacing=60 kHz, 120 kHz, etc.) within a resource block and across resource blocks. Throughout this disclosure, the term “band” refers to the frequency band of the subcarrier frequencies within the contiguous resource blocks allocated to a mobile communication device.

FIG. 3B shows an example of multiplexing of DMRS for four layers (notice the four combs, one for each DMRS antenna port). Unlike the DMRS scheme shown in FIG. 3A, when there are more than two combs for FDM'd DMRS ports, the channel estimation performance is different for each port because the structure of the DMRS for each port within the resource block is different. The DMRS ports have varying distances from an edge of the resource block; therefore, the channel estimation quality will be different for each DMRS antenna port. FIG. 3B shows an example of four DMRS ports that are FDM'd using 4 combs. The average channel estimation MSE is the same for ports 2 and 3. The average channel estimation MSE is the same for ports 1 and 4. The average channel estimation MSE is smaller for ports 2 and 3 than it is for ports 1 and 4. Accordingly, when there are more than two combs for FDM'd DMRS ports, how the data streams are assigned to the DMRS antenna ports affect the data stream demodulation performance.

Based on channel estimation MSE analysis, it was found empirically that the combs having the smallest worst-case distance from the band edges usually have the smallest channel estimation MSE. Therefore, by examining the DMRS structure, the ranking of the combs in terms of channel estimation MSE may be determined using the “worst-case distance from the band-edges” metric.

Channel estimation MSE may be different for each DMRS port. Channel estimates for subcarriers between the DMRS tones may be interpolated. Channel estimates for subcarriers between a band edge and the DMRS tone closest to that band edge may be extrapolated. In general, channel estimation extrapolation is less accurate than interpolation. As a result, the DMRS ports on a comb that are far from an edge of the allocated band typically have higher channel estimation MSE when averaged over all the allocated tones.

To perform channel estimation using the DMRS, assume Zₚ is the vector of DMRS tones received at an antenna of the mobile communication device (i.e., the mobile communication device 100) transmitted from an antenna port at an eNB (e.g., the first BTS 193 or the second BTS 198). Then, for each element of Zₚ, the mobile communication device 100 may perform descrambling according to equation 1:

Yₚ(i)=s*(i)Zₚ(i) (1)

In equation 1, s*(i) may represent the modulation symbol used by DMRS tones before precoding. s*(i) may have unit energy, such that |s*(i)|²=1. Descrambling may involve removing the modulation symbol employed by the DMRS tones to obtain the channel information. Ignoring the contribution from noise to the received signal, the vector of DMRS tones may be characterized by equation 2:

Zₚ(i)=H_{P}(i)s(i) (2)

In equation 2, Yₚ(i)=Hₚ(i), and Hₚ may be the precoded channel to be estimated. In an aspect, channel estimation for the precoded channel at the PDSCH tones may be performed by equation 3:

Ĥ_{d}=WYₚ (3)

In equation 3, Ĥ_{d} may be the estimated precoded channel at the PDSCH tones, Yₚ may be the vector of DMRS tones after “descrambling,” which is obtained by removing the modulation symbol used by the DMRS tones, and W may be the minimum mean-square error (MMSE) channel estimator. The MMSE channel estimator may be characterized by equation 4:

$$W = {{R}_{{H}_{d} {H}_{p}} ( {R}_{{H}_{p}} + \frac{1}{SNR} I )}^{- 1} \qquad ( 4 )$$

In equation 4, R_{H}_{ₚ} may correspond to the channel correlation matrix of the precoded channel at the DMRS tones, and R_{H}_{_{d}}_{H}_{ₚ} may correspond to the channel cross correlation between the precoded channel at the PDSCH tones and the precoded channel at the DMRS tones. To compute R_{H}_{ₚ} and R_{H}_{_{d}}_{H}_{ₚ}, the mobile communication device 100 needs to know the second order statistics of the precoded channel.

However, the second order statistics of the precoded channel may not be available to the mobile communication device 100. Therefore, the precoded channel is assumed to be a wide-sense stationary uncorrelated scattering (WSSUS) channel with a rectangular power delay profile (PDP) and Jakes Doppler spectrum. Then, all that is needed may be the time support of the PDP, the Doppler, and the signal-to-noise ratio (SNR) of the received signal to compute W. The estimator obtained with these assumptions may be called the robust minimum mean-square error (RMMSE) channel estimator. For the RMMSE channel estimator, R_{H}_{_{d}}_{H}_{ₚ} and R_{H}_{ₚ} are replaced by the corresponding matrices \hat{R}_{H}_{_{d}}_{H}_{ₚ} and \hat{R}_{H}_{ₚ}, which are computed with the assumption of a WSSUS channel with rectangular PDP and Jakes Doppler spectrum.

The channel estimation MSE for each comb can be computed by evaluating equation 5:

$$\begin{matrix}\begin{matrix}MSE = E \{ {‖ {H}_{d} - {W}_{RMMSE} {Y}_{p} ‖}^{2} \} \\ = Trace \{ {R}_{{H}_{d}} - {R}_{{H}_{d} {H}_{p}} {W}_{RMMSE}^{H} - {W}_{RMMSE} {R}_{{H}_{d} {H}_{p}}^{H} + \\ {W}_{RMMSE} ( {R}_{{H}_{p}} + \frac{1}{SNR} I ) {W}_{RMMSE}^{H} \}\end{matrix} & ( 5 ) \\ where \\ {W}_{RMMSE} = {{\hat{R}}_{{H}_{d} {H}_{p}} ( {\hat{R}}_{{H}_{p}} + \frac{1}{SNR} I )}^{- 1} & \end{matrix}$$

The MSE can be evaluated for each comb for various channel models, for which the true statistics R_{H}_{_{d}} and R_{H}_{_{d}}_{H}_{ₚ} are known. For simplicity, the true precoded channel may be assumed in the analysis to be a zero-mean complex Gaussian channel with a certain PDP. It has been observed that the channel estimation based on the DMRS tones on the combs having the smallest worst-case distance from the band edges usually have the smallest MSE.

As illustrated by the first arrow 312 in FIG. 3B, the last DMRS tone 310 of DMRS antenna port 1 is spaced from a first edge 360 of the frequency band 350 by three subcarriers. Further, as illustrated by the second arrow 342, the first DMRS tone 340 of DMRS antenna port 4 is spaced from a second edge 370 of the frequency band 350 by three subcarriers. Notice that the comb for the DMRS antenna port 1 has distance of three subcarriers from the first band edge 360, and zero subcarrier from the second band edge 370. Therefore, the worst-case distance of the comb for DMRS antenna port 1 from any band edge is three subcarriers. Similarly, the comb for DMRS antenna port 4 has distance of three subcarriers from the second band edge 370, and zero subcarrier from the first band edge 360. The worst-case distance of the comb for DMRS antenna port 4 from any band edge is three subcarriers. As a result, DMRS port 1 and DMRS port 4 may be said to be mirror images of each other and the channel estimation MSE for DMRS antenna port 1 may be substantially equal to the channel estimation MSE for DMRS antenna port 4. Similarly, DMRS port 2 and DMRS port 3 may be said to be mirror images of each other and the channel estimation MSE for DMRS antenna port 2 may be substantially equal to the channel estimation MSE for DMRS antenna port 3. The worst-case distance of the combs for DMRS antenna ports 2 and 3 are two subcarriers.

In various example embodiments, for the SU-MIMO case, the DMRS antenna ports may be sorted in ascending order of channel estimation MSE by the eNB, and transmission layers are assigned to the DMRS antenna ports, with the first transmission layer assigned to the DMRS antenna port with the smallest MSE, the second transmission layer assigned to the DMRS antenna port with the next smallest MSE, and the n-th transmission layer assigned to the DMRS antenna port with the n-th smallest MSE, where n is the number of DMRS antenna ports.

DMRS ports on the combs with the largest worst-case distance from the band edges tend to have the largest MSE (e.g., DMRS ports 1 and 4 in FIG. 3B). Since the channel estimation MSE may be different between the DMRS antenna ports, the manner in which the transmission layers are mapped to the DMRS antenna ports may affect performance of the mobile communication device 100.

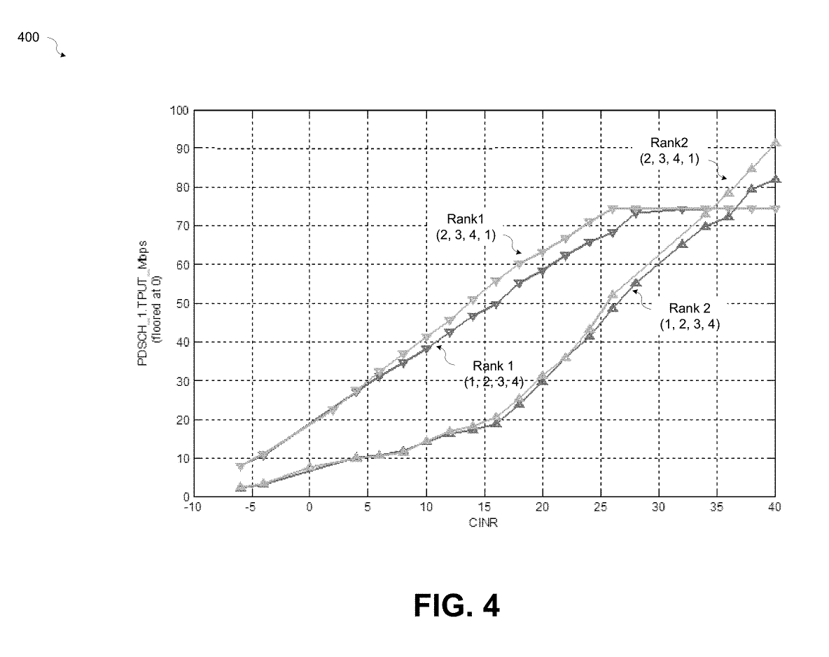

FIG. 4 is a graph 400 illustrating a comparison of transmission layer to DMRS mapping for four DMRS antenna ports in accordance with certain aspects of the present disclosure. As illustrated in FIG. 4, two mapping schemes were simulated for each of transmission rank 1 and transmission rank 2, where the rank indicates the number of transmission layers transmitted. For example, in a 2×2 MIMO system where base station transmits two “layers,” the rank of the communication link between the base station and the mobile communication device is two, while where base station transmits one “layer,” the rank of the communication link between the base station and the mobile communication device is one. In the first mapping scheme, transmission layers were assigned to the DMRS antenna ports in an order of Port 1 Port 2-Port 3-Port 4. That is, layer 1 is assigned to port 1, layer 2 is assigned to port 2, layer 3 is assigned to port 3, and layer 4 is assigned to port 4.

In the second mapping scheme, transmission layers were assigned to the DMRS antenna ports in an order of Port 2 Port 3-Port 4-Port 1. That is, layer 1 is assigned to port 2, layer 2 is assigned to port 3, layer 3 is assigned to port 4, and layer 4 is assigned to port 1.

FIG. 4 shows that assigning port 2 and 3 to layers 1 and 2 leads to higher Physical Downlink Shared Channel (PDSCH) throughput than assigning ports 1 and 2 to layers 1 and 2 since, as stated above, the average channel estimation quality error is smaller for ports 2 and 3 than for ports 1 and 4. In this example, no physical resource block (PRB) bundling is assumed. The curve labeled Rank 1 (2, 3, 4, 1) has one data stream assigned to port 2, which has a higher PDSCH throughput than the curve labeled Rank 1 (1, 2, 3, 4) with one data stream assigned to port 1. The curve labeled Rank 2 (2, 3, 4, 1) has two data streams assigned to ports 2 and 3 respectively, which has a higher PDSCH throughput than the curve labeled Rank 2 (1, 2, 3, 4) with two data streams assigned to ports 1 and 2 respectively. Since the MIMO channel has medium correlation in this example, the optimum rank is small, even at high SNR. Therefore, mapping the DMRS antenna ports with better channel estimation MSE (i.e., DMRS antenna ports 2 and 3) to layer 1 and 2 achieves higher throughput.

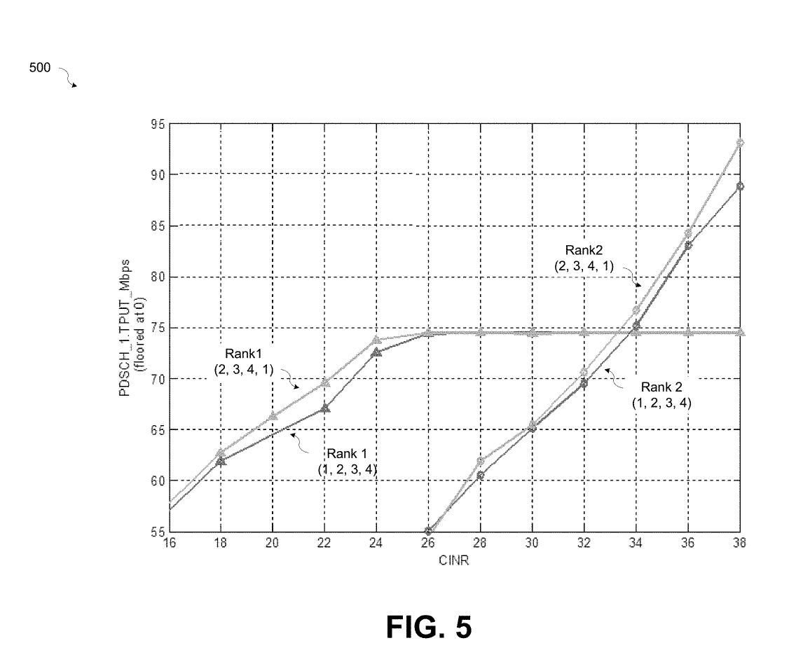

FIG. 5 is a graph 500 illustrating a comparison of transmission layer to DMRS mapping for four DMRS antenna ports with physical resource block (PRB) bundling in accordance with certain aspects of the present disclosure. The same two transmission layer to DMRS mappings were used for the simulation in FIG. 5. Edge tone effects are mitigated by PRB bundling of three PRBs. In FIG. 5, the PRB bundling increased the number of DMRS tones for each DMRS antenna port used for channel estimation from 4 tones to 12 tones. As illustrated in FIG. 5, mapping the DMRS antenna ports with better channel estimation MSE (2,3,4,1) to layer 1 and layer 2 still achieved higher throughput than using (1,2,3,4) DMRS mapping.

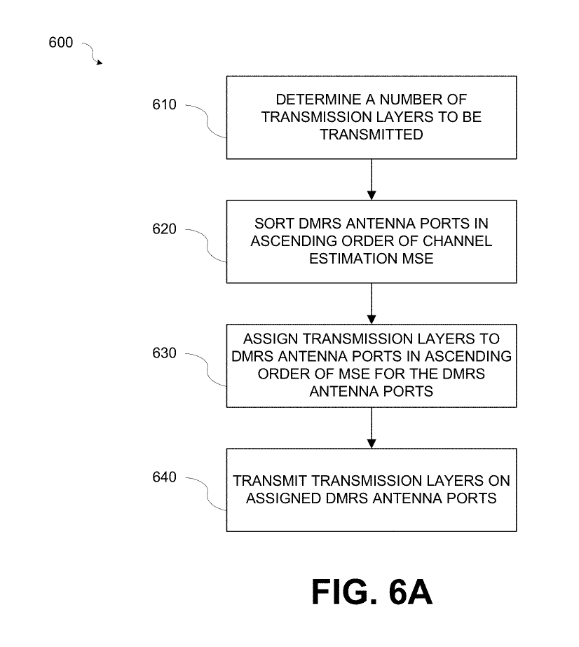

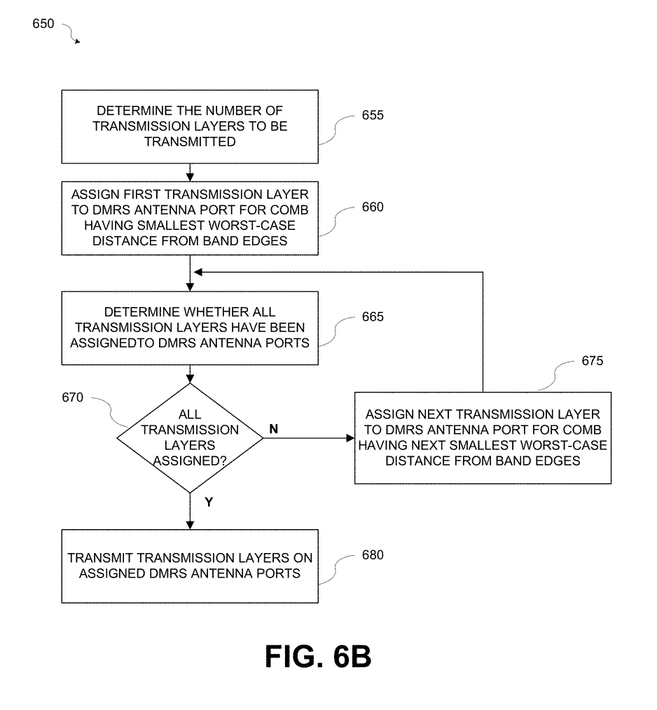

FIG. 6A is a flowchart illustrating a method 600 for mapping transmission layers to DMRS antenna ports for a SU-MIMO transmission scheme in accordance with certain aspects of the present disclosure. The operations may include i) sorting the DMRS antenna ports in an ascending order of channel estimation MSE; and ii) assigning the transmission layers to the DMRS antenna ports, i.e., the first layer to the DMRS antenna port with the smallest channel estimation MSE, and the last layer to the DMRS antenna port with the largest channel estimation MSE. (Note that the DMRS ports on the combs with the largest worst-case distance from any band edge tend to have the worst channel estimation MSE). Referring to FIG. 6A, at block 610, the controller 194 may determine the number of transmission layers to be transmitted by the eNB 193. For example, the controller 194 may determine based on the SE the number of transmission layers to be transmitted.

At block 620, the controller 194 may control the eNB 193 to sort the plurality of DMRS antenna ports in ascending order of channel estimation MSE. For example, the DMRS ports on the combs having the largest worst-case distance from the band edges may have the largest channel estimation MSE, while the DMRS ports on the combs having the smallest worst-case distance from the band edges may have the smallest channel estimation MSE. Further, DMRS ports that are mirror images of each other may have substantially equal channel estimation MSE.

At block 630, the controller 194 may control the eNB 193 to assign transmission layers to the plurality of DMRS antenna ports in ascending order of channel estimation MSE for the plurality of DMRS antenna ports. For example, the controller 194 may control the eNB 193 to assign a first transmission layer to the DMRS antenna port for the comb having the smallest worst-case distance from the band edges (i.e., with the smallest channel estimation MSE), the second transmission layer to the DMRS antenna port for the comb having the next smallest worst-case distance from the band edges (i.e., with the next smallest channel estimation MSE), and the n-th transmission layer to the DMRS antenna port for the comb with the n-th smallest (i.e., the largest among the n chosen DMRS antenna ports) channel estimation MSE, wherein n is the number of DMRS antenna ports to be assigned.

For example, referring again to FIG. 3B, when the eNB 193 transmits one transmission layer, the controller 194 may assign the transmission layer to DMRS antenna port 2. When the eNB 193 transmits two transmission layers, the controller 194 may assign the first and second transmission layers to DMRS antenna ports 2 and 3, respectively. When the eNB 193 transmits three transmission layers, the controller 194 may assign to the first, second, and third transmission layers to DMRS antenna ports 2, 3, and 4, respectively. When the eNB 193 transmits four transmission layers, the controller 194 may assign the first, second, third, and fourth transmission layers to DMRS antenna ports 2, 3, 4, and 1, respectively.

For DMRS ports that are mirror images of each other (e.g., DMRS ports 2 and 3, and DMRS ports 1 and 4) the channel estimation MSE is substantially equal; therefore, transmission layers may be assigned to the mirror image DMRS antenna ports in any order. For example, the first transmission layer may be assigned to DMRS antenna port 3 rather than DMRS antenna port 2 and the second transmission layer may be assigned to DMRS antenna port 2 rather than DMRS antenna port 3. At block 640, the controller 194 may control the eNB 193 to transmit the transmission layers on the assigned DMRS antenna ports. An example of a SU-MIMO transmission scheme with up to 4 layers for 4 FDM'd DMRS ports is shown below. As in LTE, the number of layers and antenna ports are conveyed in DCI.
1 layer, port 2
2 layers, ports 2, 3
3 layers, ports 2, 3, 4
4 layers, ports 2, 3, 4, 1

FIG. 6B is a flowchart illustrating a method 650 for assigning transmission layers to DMRS antenna ports in accordance with certain aspects of the present disclosure. The flowchart FIG. 6B may implement the operation of block 630 in FIG. 6A. Referring to FIG. 6B, at block 655, the controller 194 may determine the number of transmission layers to be transmitted by the eNB 193. At block 660, the controller 194 may control the eNB 193 to assign a first transmission layer to the DMRS antenna port for the comb having the smallest worst-case distance from the band edges. For DMRS antenna ports that are mirror images of each other in terms of their DMRS patterns, the controller 194 may control the eNB 193 to assign the first transmission layer to either unassigned mirror image DMRS antenna ports.

At block 665, the controller 194 or may determine whether all transmission layers to be transmitted have been assigned to DMRS antenna ports. In response to determining that all transmission layers to be transmitted have not been assigned to DMRS antenna ports (670-N), at block 675 the controller 194 may control the eNB 193 to assign a next transmission layer to the DMRS antenna port for the comb having the next smallest worst-case distance from the band edges. For DMRS antenna ports that are mirror images of each other in terms of their DMRS patterns, the controller 194 may control the eNB 193 to assign the next transmission layer to either unassigned mirror image DMRS antenna ports.

The controller 194 may again determine whether all transmission layers to be transmitted have been assigned to DMRS antenna ports at block 665. In response to determining that all transmission layers to be transmitted have been assigned to DMRS antenna ports (670-Y), at block 680 the controller 194 may control the eNB 193 to transmit the transmission layers on the assigned DMRS antenna ports.

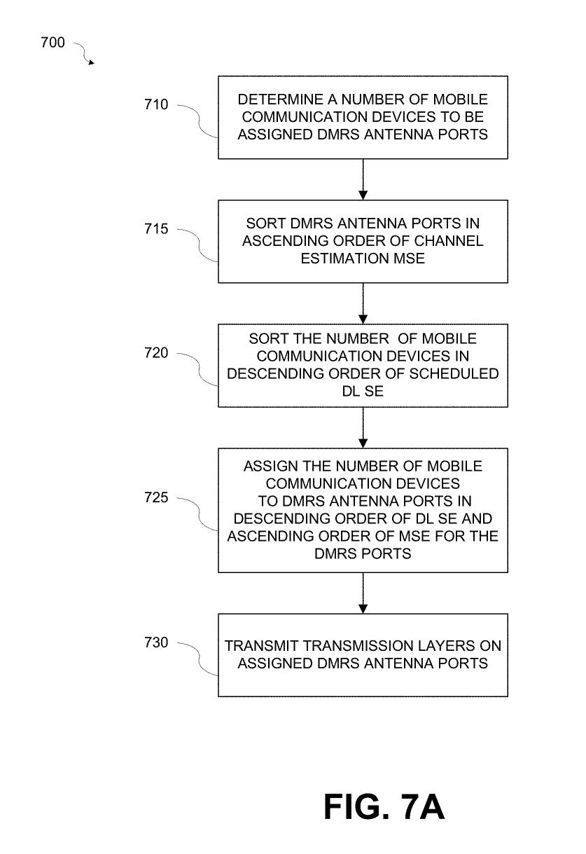

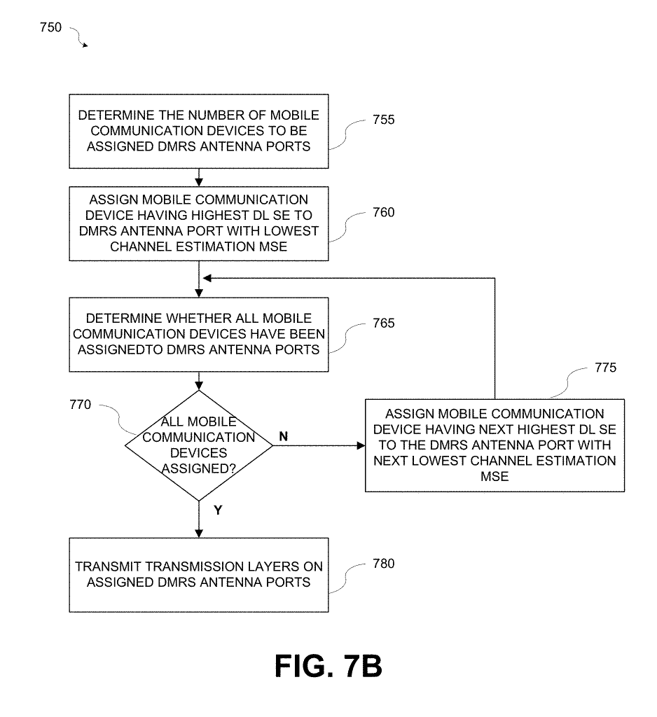

FIG. 7A is a flowchart illustrating a method 700 for mapping mobile communication devices to DMRS antenna ports for a MU-MIMO transmission scheme in accordance with certain aspects of the present disclosure. In the MU-MIMO case, each of a plurality of mobile communication devices may be assigned one DMRS antenna port (i.e., a maximum of transmission rank 1). Notice that channel estimation degradation due to band-edge effects is more pronounced at higher SNR. Therefore, it may be advantageous to assign a DMRS antenna port with smaller MSE to a mobile communication device with larger SE.

The operations may include i) sorting the DMRS antenna ports in an ascending order of channel estimation MSE as in the SU-MIMO example discussed above; ii) sorting the mobile communication devices in descending order of the scheduled DL SE; and iii) assigning the mobile communication devices to the DMRS antenna ports, i.e., the mobile communication device with the highest SE to the DMRS antenna port with the lowest channel estimation MSE, and the mobile communication device with the lowest SE to the DMRS antenna port with the highest channel estimation MSE. Referring to FIG. 7A, at block 710, the controller 194 may determine a number of mobile communication devices to be assigned DMRS antenna ports.

At block 715, the controller 194 may control the eNB 193 to sort the plurality of DMRS antenna ports in ascending order of channel estimation MSE. For example, the DMRS antenna ports for the combs having the largest worst-case distance from the band edges may have the highest channel estimation MSE while the DMRS antenna ports for the combs having the smallest worst-case distance from the band edges may have the lowest channel estimation MSE. Further, DMRS antenna ports that are mirror images of each other in terms of their DMRS patterns may have substantially equal channel estimation MSE.

At block 720, the plurality of mobile communication devices may be sorted in descending order of scheduled downlink (DL) spectral efficiency (SE). For example, the controller 194 may control the eNB 193 to determine the scheduled order of downlink transmissions to the plurality of mobile communication devices (e.g., the first mobile communication device 100a and the second mobile communication device 100b) and may sort the plurality of mobile communication devices in descending order based on the DL SE. The controller 194 may determine that a mobile communication device having a higher data throughput (i.e., higher bits per second or higher spectral efficiency) has a larger DL SE.

At block 725, the controller 194 may control the eNB 193 to assign the plurality of mobile communication devices to the DMRS antenna ports in descending order of DL SE and ascending order of channel estimation MSE for the DMRS antenna ports. For example, the controller 194 may control the eNB 193 to assign the mobile communication device having the highest DL SE to the DMRS antenna port with the lowest channel estimation MSE, the mobile communication device having the next highest DL SE to the DMRS antenna port with the next lowest channel estimation MSE, and the n-th mobile communication device having the n-th highest DL SE to the DMRS antenna port with the n-th lowest channel estimation MSE, wherein n is the number of DMRS antenna ports to be assigned. At block 730 the controller 194 may control the eNB 193 to transmit the transmission layers to the plurality of mobile communication devices on the assigned DMRS antenna ports.

FIG. 7B is a flowchart illustrating a method 750 for assigning mobile communication devices to DMRS antenna ports according to various embodiments. The flowchart FIG. 7B may implement the operation of block 725 in FIG. 7A. Referring to FIGS. 7A and 7B, at block 755, the controller 194 may determine the number of mobile communication devices to be assigned DMRS antenna ports. For example, the controller 194 may determine the number of mobile communication devices having a scheduled DL SE.

At block 760, the controller 194 may control the eNB 193 to assign a mobile communication device having a highest DL SE to the DMRS antenna port for the comb having the smallest worst-case distance from the band edges. For DMRS antenna ports that are mirror images of each other in terms of their DMRS patterns, the controller 194 may control the eNB 193 to assign the mobile communication device to either unassigned mirror image DMRS antenna ports.

At block 765, the controller 194 may determine whether all mobile communication devices have been assigned to DMRS antenna ports. In response to determining that all mobile communication devices have not been assigned to DMRS antenna ports (770-N), at block 775 the controller 194 may control the eNB 193 to assign a mobile communication device having a next highest DL SE to the DMRS antenna port on the comb having the next smallest worst-case distance from the band edges. For DMRS antenna ports that are mirror images of each other in terms of their DMRS patterns, the controller 194 may control the eNB 193 to assign the mobile communication device to either unassigned mirror image DMRS antenna ports.

The controller 194 may again determine whether all mobile communication devices have been assigned to DMRS antenna ports at block 765. In response to determining that all mobile communication devices have been assigned to DMRS antenna ports (770-Y), at block 7680 the controller 194 may control the eNB 193 to transmit the transmission layers to the plurality of mobile communication devices on the assigned DMRS antenna ports.

The methods 600, 655, 700, and 755, respectively, may be embodied on a non-transitory computer readable medium, for example, but not limited to, eNB memory (not shown) or other non-transitory computer readable medium known to those of skill in the art, having stored therein a program including computer executable instructions for making a processor, computer, or other programmable device execute the operations of the methods.

Those of ordinary skill in the art will appreciate that while the various examples have been described in terms of four combs for FDM'd DMRS ports, any number of combs greater than two may be used without departing from the scope of the disclosure. Furthermore, the DMRSs for additional antenna ports (beyond the four antenna ports described here) may be further multiplexed into each comb by using, for example, but not limited to, code division multiplexing (CDM).

In various embodiments, for transmission of the PDSCH and DMRS on antenna ports, in resource blocks in which demodulation reference signals (DMRSs) are transmitted the PDSCH may be transmitted on antenna port(s) {x, x+1, . . . , x+v−1}, where v is the number of layers used for transmission of the PDSCH. For example, if the number of transmission layers is four, then v=4. x is some non-negative integer and is the number of antenna ports assigned to other type of reference signals, such as cell-specific reference signal (CRS). DMRSs are supported for transmission of the PDSCH and are transmitted on antenna ports {x, x+1, . . . , x+v−1}.

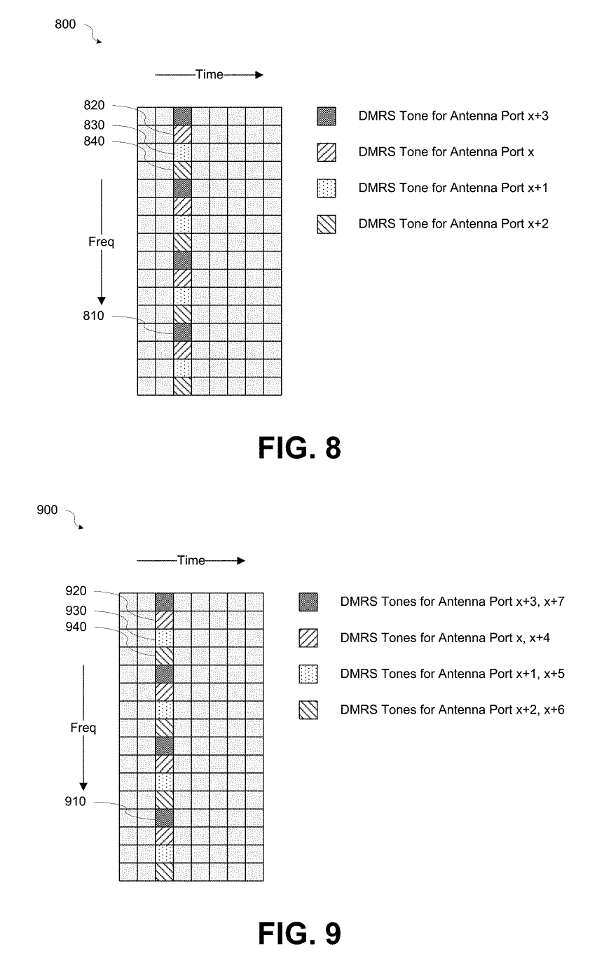

FIG. 8 is a diagram illustrating an example of mapping DMRSs for four antenna ports to resource elements on four combs of a resource block 800 in accordance with certain aspects of the present disclosure. In the case of four antenna ports, DMRSs transmitted on antenna ports {x, x+1, x+2, x+3} are mapped to the resource elements as illustrated. Referring to FIG. 8, a first DMRS tone 810 may be transmitted on antenna port x+3, a second DMRS tone 820 may be transmitted on antenna port x, a third DMRS tone 830 may be transmitted on antenna port x+1, and a fourth DMRS tone 840 may be transmitted on antenna port x+2.

For SU-MIMO transmission with up to four transmission layers, downlink control information (DCI) indicates the number of transmission layers and the associated antenna ports. Referring to FIG. 8, the transmission layers may be assigned to the antenna ports as follows:
1 layer, port x
2 layers, ports x, x+1
3 layers, ports x, x+1, x+2
4 layers, ports x, x+1, x+2, x+3

DCI indicates that the number of combs is 4 to inform the DMRS structure. For SU-MIMO transmission, DCI indicates whether the resource elements on the combs that are not assigned to any transmission layer are left unused, or used by other signals such as PDSCH.

In various embodiments, the DMRSs for additional antenna ports (beyond the four antenna ports described here) can be further multiplexed into each comb by using code division multiplexing (CDM). Each DMRS for an antenna port may be associated with a comb.

FIG. 9 is a diagram illustrating an example of mapping DMRSs for eight antenna ports to resource elements on four combs of a resource block 900 in accordance with certain aspects of the present disclosure. To support up to eight antenna ports, the frequency domain code-division multiplexing (CDM) (achieved by time domain cyclic shift) may be employed to support the additional four antenna ports. The DMRSs for the first set of antenna ports {x, x+1, x+2, x+3} are FDM'd. The DMRSs for the second set of antenna ports {x+4, x+5, x+6, x+7} are FDM'd among themselves, but code-division multiplexed with DMRSs for the first set of antenna ports {x, x+1, x+2, x+3}. (Notice that each comb has 2 DMRS ports)

For SU-MIMO transmission with up to eight transmission layers, downlink control information (DCI) indicates the number of transmission layers and the associated antenna ports. Referring to FIG. 9, the transmission layers may be assigned to the antenna ports as follows:
1 layer, port x
2 layers, ports x, x+1
3 layers, ports x, x+1, x+2
4 layers, ports x, x+1, x+2, x+3
5 layers, ports x, x+1, x+2, x+3, x+4
6 layers, ports x, x+1, x+2, x+3, x+4, x+5
7 layers, ports x, x+1, x+2, x+3, x+4, x+5, x+6
8 layers, ports x, x+1, x+2, x+3, x+4, x+5, x+6, x+7

DCI indicates that the number of combs is 4, with each comb having 2 cyclic shifts, to inform the DMRS structure. For SU-MIMO transmission, DCI indicates whether the resource elements on the combs that are not assigned to any transmission layer are left unused, or used by other signals such as PDSCH.

For MU-MIMO transmission with up to 4 transmission layers for a mobile communication device, DCI indicates the number of transmission layers for the mobile communication device and the associated antenna ports:
1 layer, port x
1 layer, port x+1
1 layer, port x+4
1 layer, port x+5
2 layers, ports x, x+1
2 layers, ports x+4, x+5
3 layers, ports x, x+1, x+2
3 layers, ports x+4, x+5, x+6
4 layers, ports x, x+1, x+2, x+3
4 layers, ports x+4, x+5, x+6, x+7

DCI indicates that the number of combs is 4, with each comb having 2 cyclic shifts, to inform the DMRS structure. In addition, for MU-MIMO, DCI indicates the set of combs to be reserved for DMRS. This set of combs can be larger than the set of the combs that are assigned to the mobile communication device for its transmission layers. DCI also indicates whether the resource elements on rest of the combs are left unused, or used by other signals such as PDSCH. With these constraints, if there are no more than 2 transmission layers for a mobile communication device, the DMRS ports on the best combs in terms of channel estimation MSE are guaranteed to be assigned for the transmission of these layers.

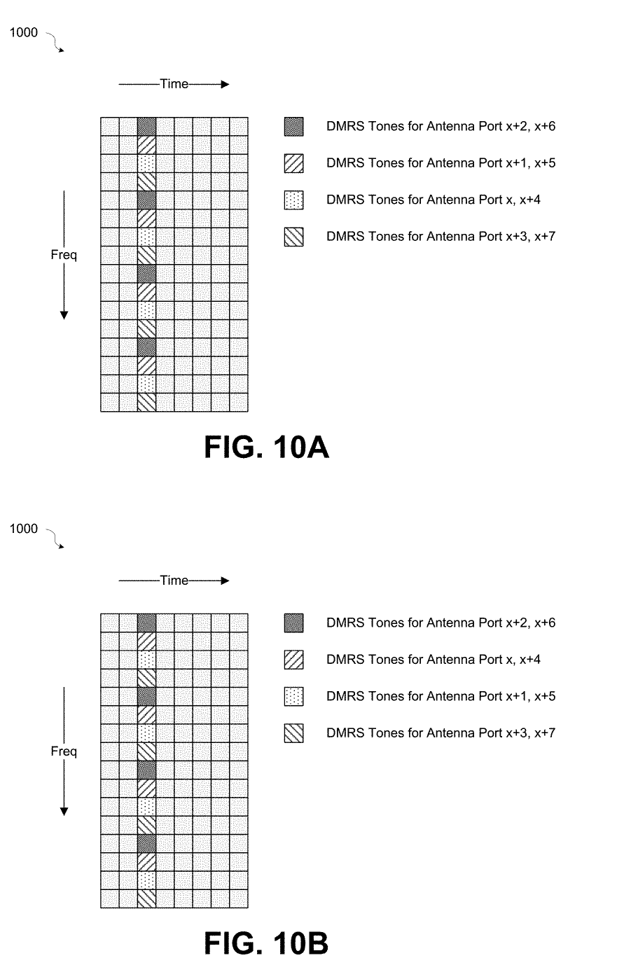

FIGS. 10A and 10B are diagrams illustrating alternate example mappings of DMRSs for eight antenna ports to resource elements on four combs of a resource block 1000 in accordance with certain aspects of the present disclosure.

In order to randomize the DMRS interference from the other cells, the mapping of DMRSs for the antenna ports to the combs may be randomized. For example, this may be achieved by cycling through the mappings shown in FIGS. 9, 10A and 10B, according to the cell ID and the subframe number.

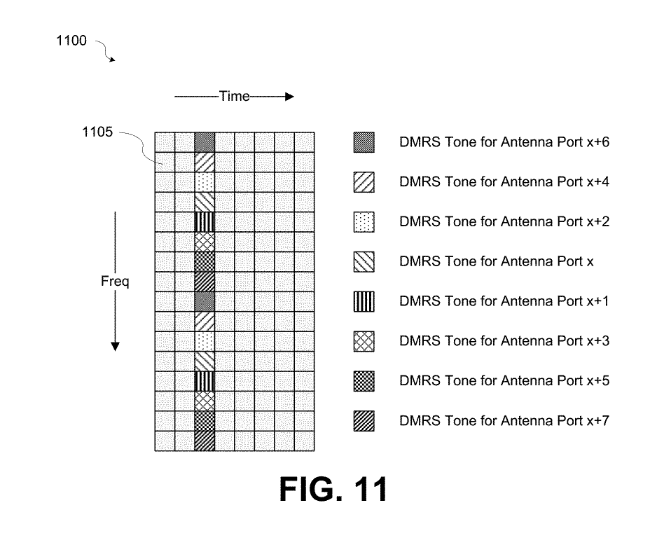

FIG. 11 is a diagram illustrating an example of mapping DMRSs for eight antenna ports to resource elements on eight combs of a resource block 1100 in accordance with certain aspects of the present disclosure. Referring to FIG. 11, DMRS tones transmitted on antenna ports {x, x+1, x+2, x+3, x+4, x+5, x+6, x+7} may be mapped to resource elements on 8 combs in ascending order of channel estimation MSE.

For SU-MIMO transmission with up to eight transmission layers, downlink control information (DCI) indicates the number of transmission layers and the associated antenna ports. Referring to FIG. 11, the transmission layers may be assigned to the antenna ports as follows:
1 layer, port x
2 layers, ports x, x+1
3 layers, ports x, x+1, x+2
4 layers, ports x, x+1, x+2, x+3
5 layers, ports x, x+1, x+2, x+3, x+4
6 layers, ports x, x+1, x+2, x+3, x+4, x+5
7 layers, ports x, x+1, x+2, x+3, x+4, x+5, x+6
8 layers, ports x, x+1, x+2, x+3, x+4, x+5, x+6, x+7

DCI indicates that the number of combs is 8, to inform the DMRS structure. For SU-MIMO transmission, DCI indicates whether the resource elements on the combs that are not assigned to any transmission layer are left unused, or used by other signals such as PDSCH.

For MU-MIMO transmission with up to four transmission layers for a mobile communication device, DCI indicates the number of transmission layers for the mobile communication device and the associated antenna ports:
1 layer, port x
1 layer, port x+1
1 layer, port x+2
1 layer, port x+3
2 layers, ports x, x+2
2 layers, ports x+1, x+3
3 layers, ports x, x+2, x+4
3 layers, ports x+1, x+3, x+5
4 layers, ports x, x+2, x+4, x+6
4 layers, ports x+1, x+3, x+5, x+7

DCI indicates that the number of combs is 8, to inform the DMRS structure. In addition, for MU-MIMO, DCI indicates the set of combs to be reserved for DMRS. This set of combs can be larger than the set of the combs that are assigned to the mobile communication device for its transmission layers. DCI also indicates whether the resource elements on rest of the combs are left unused, or used by other signals such as PDSCH.

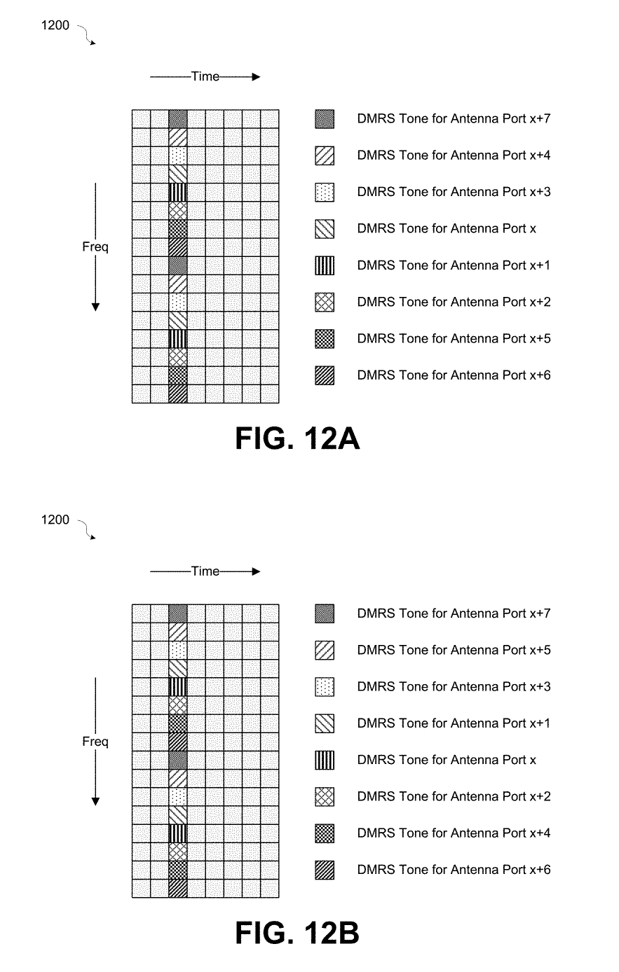

FIGS. 12A and 12B are diagrams illustrating alternate example mappings of DMRSs for eight antenna ports to resource elements on eight combs of a resource block 1200 in accordance with certain aspects of the present disclosure.

In order to randomize the DMRS interference from the other cells, the mapping of DMRSs for the antenna ports to the combs may be randomized. For example, this may be achieved by cycling through the mappings shown in FIGS. 11, 12A and 12B, according to the cell ID and the subframe number.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for mapping transmission layers to demodulation reference signal (DMRS) antenna ports, the method comprising:
determining a number of transmission layers to be transmitted;
sorting a plurality of DMRS antenna ports in ascending order based on a channel estimation mean square error (MSE); and
assigning the number of transmission layers to the plurality of DMRS antenna ports in ascending order of the channel estimation MSE.

2. The method of claim 1, further comprising multiplexing DMRSs for the plurality of DMRS antenna ports in a comb fashion, wherein a number of combs is greater than 2.

3. The method of claim 1, wherein DMRS tones for each of the plurality of DMRS antenna ports are uniformly spaced in frequency.

4. The method of claim 1, wherein the plurality of DMRS antenna ports comprises greater than two DMRS antenna ports.

5. The method of claim 1, wherein the channel estimation MSE is highest for DMRS antenna ports for combs having a largest worst-case distance from edges of a band of subcarrier frequencies in a resource block.

6. The method of claim 5, wherein DMRS antenna ports having DMRS tones on the combs with a same worst-case distance from the edges of the band are mirror images of each other, and
wherein the assigning transmission layers to the plurality of DMRS antenna ports further comprises assigning transmission layers to unassigned mirror image DMRS antenna ports in any order.

7. The method of claim 5, wherein the assigning the number of transmission layers to the plurality of DMRS antenna ports comprises:
assigning a first transmission layer to a DMRS antenna port for a comb with a smallest worst-case distance from the edges of the band;
assigning a second transmission layer to a DMRS antenna port for a comb with a next smallest worst-case distance from the edges of the band; and
assigning an n-th transmission layer to a DMRS antenna port for a comb with an n-th smallest worst-case distance from the edges of the band, where n is a number of DMRS antenna ports.

8. The method of claim 7, further comprising multiplexing the DMRSs for the plurality of DMRS antenna ports in a comb fashion, wherein a number of combs is greater than 2

9. The method of claim 7, wherein DMRS tones for each of the plurality of DMRS antenna port are uniformly spaced in frequency.

10. The method of claim 1, wherein the DMRSs for the plurality of DMRS antenna ports assigned to transmission layers are frequency division multiplexed.

11. The method of claim 1, wherein the DMRSs for a first set of the plurality of DMRS antenna ports assigned to the number of transmission layers are frequency division multiplexed; and
the DMRSs for a second set of the plurality of DMRS antenna ports assigned to the number of transmission layers are frequency division multiplexed, and code division multiplexed with the DMRSs for the first set of the plurality of DMRS antenna ports.

12. A method for mapping mobile communication devices to demodulation reference signal (DMRS) antenna ports, the method comprising:
determining a number of the mobile communication devices to be assigned to a plurality of DMRS antenna ports;
sorting the plurality of DMRS antenna ports in ascending order based on a channel estimation mean square error (MSE);
sorting the number of the mobile communication devices in descending order of a downlink (DL) spectral efficiency (SE); and
assigning the number of the mobile communication devices to the plurality of DMRS antenna ports in descending order of the DL SE and ascending order of the channel estimation MSE.

13. The method of claim 12, further comprising multiplexing the DMRSs for the plurality of DMRS antenna ports in a comb fashion, wherein a number of combs is greater than 2.

14. The method of claim 12, wherein DMRS tones for each of the plurality of DMRS antenna port are uniformly spaced in frequency.

15. The method of claim 12, wherein the assigning the number of the mobile communication devices comprises assigning a mobile communication device with a highest SE to a DMRS antenna port with a smallest channel estimation MSE, and a mobile communication device with a lowest SE to a DMRS antenna port with a highest channel estimation MSE.

16. The method of claim 12, wherein the plurality of the DMRS antenna ports comprises greater than two DMRS antenna ports.

17. The method of claim 12, wherein the channel estimation MSE is highest for DMRS antenna ports for combs having a largest worst-case distance from edges of a band of subcarrier frequencies in a resource block.

18. The method of claim 17, wherein the DMRS antenna ports having DMRS tones on the combs with a same worst-case distance from the edges of the band are mirror images of each other, and
wherein the assigning the number of the mobile communication devices to the plurality of DMRS antenna ports further comprises assigning the number of the mobile communication devices to unassigned mirror image DMRS antenna ports in any order.

19. The method of claim 17, wherein a mobile communication device having a higher data throughput has a higher DL SE.

20. The method of claim 19, wherein the assigning the number of mobile communication devices to the plurality of the DMRS antenna ports comprises:
assigning a first mobile communication device having a highest DL SE to a DMRS antenna port for a comb with a smallest worst-case distance from the edges of the band;
assigning a second mobile communication device having a next highest DL SE to a DMRS antenna port for a comb with a next smallest worst-case distance from the edges of the band; and
assigning an n-th mobile communication device having an n-th highest DL SE to a DMRS antenna port for a comb with an n-th smallest worst-case distance from the edges of the band, where n is a number of the DMRS antenna ports.

21. The method of claim 12, wherein the DMRSs for the DMRS antenna ports assigned to transmission layers transmitted to each of the number of the mobile communication devices are frequency division multiplexed.

22. The method of claim 12, wherein the DMRSs for a first set of the plurality of DMRS antenna ports assigned to transmission layers transmitted to each of the number of mobile communication devices are frequency division multiplexed; and
the DMRSs for a second set of the plurality of DMRS antenna ports assigned to the transmission layers transmitted to each of the number of mobile communication devices are frequency division multiplexed, and code division multiplexed with the DMRSs for the first set of the plurality of DMRS antenna ports.

23. A non-transitory computer readable medium having stored thereon instructions for causing one or more processors to perform operations comprising:
determining a number of mobile communication devices to be assigned to a plurality of DMRS antenna ports;
sorting the plurality of DMRS antenna ports in ascending order based on a channel estimation mean square error (MSE);
sorting the number of mobile communication devices in descending order of a downlink (DL) spectral efficiency (SE); and
assigning the number of mobile communication devices to the plurality of DMRS antenna ports in descending order of the DL SE and ascending order of the channel estimation MSE.

24. The non-transitory computer readable medium having stored therein instructions as defined in claim 23, wherein the plurality of the DMRS antenna ports comprises greater than two DMRS antenna ports.

25. The non-transitory computer readable medium having stored therein instructions as defined in claim 23, wherein the channel estimation MSE is highest for DMRS antenna ports for combs having a largest worst-case distance from edges of a band of subcarrier frequencies in a resource block.

26. The non-transitory computer readable medium having stored therein instructions as defined in claim 25, wherein the DMRS antenna ports having DMRS tones on the combs with a same worst-case distance from the edges of the band are mirror images of each other, and
wherein the assigning the number of the mobile communication devices to the plurality of the DMRS antenna ports further comprises assigning the number of mobile communication devices to unassigned mirror image DMRS antenna ports in any order.

27. The non-transitory computer readable medium having stored therein instructions as defined in claim 25, wherein a mobile communication device having a higher data throughput has a higher DL SE.

28. The non-transitory computer readable medium having stored therein instructions as defined in claim 27, wherein the assigning the number of the mobile communication devices to the plurality of the DMRS antenna ports comprises:
assigning a first mobile communication device having a highest DL SE to a DMRS antenna port for a comb with a smallest worst-case distance from the edges of the band;
assigning a second mobile communication device having a next highest DL SE to a DMRS antenna port for a comb with a next smallest worst-case distance from the edges of the band; and
assigning an n-th mobile communication device having an n-th highest DL SE to a DMRS antenna port for a comb with an n-th smallest worst-case distance from the edges of the band, where n is a number of the DMRS antenna ports.

29. The non-transitory computer readable medium having stored therein instructions as defined in claim 23, wherein the DMRSs for the DMRS antenna ports assigned to transmission layers transmitted to each of the number of the mobile communication devices are frequency division multiplexed.

30. The non-transitory computer readable medium having stored therein instructions as defined in claim 23, wherein the DMRSs for a first set of the plurality of DMRS antenna ports assigned to transmission layers transmitted to each of the number of mobile communication devices are frequency division multiplexed; and
the DMRSs for a second set of the plurality of DMRS antenna ports assigned to the transmission layers transmitted to each of the number of mobile communication devices are frequency division multiplexed, and code division multiplexed with the DMRSs for the first set of the plurality of DMRS antenna ports.

31. An apparatus for mapping transmission layers to demodulation reference signal (DMRS) antenna ports, the apparatus comprising:
means for determining a number of transmission layers to be transmitted;
means for sorting a plurality of DMRS antenna ports in ascending order based on a channel estimation mean square error (MSE); and
means for assigning the number of transmission layers to the plurality of DMRS antenna ports in ascending order of the channel estimation MSE.

32. The apparatus of claim 31, further comprising means for multiplexing DMRSs for the DMRS antenna ports in a comb fashion, wherein the number of combs is greater than 2.

33. The apparatus of claim 31, wherein DMRS tones for each of the plurality of DMRS antenna ports are uniformly spaced in frequency.

34. The apparatus of claim 31, wherein the plurality of the DMRS antenna ports comprises greater than two DMRS antenna ports.

35. The apparatus of claim 31, wherein the channel estimation MSE is highest for DMRS antenna ports for combs having a largest worst-case distance from edges of a band of subcarrier frequencies in a resource block.

36. The apparatus of claim 35, wherein the DMRS antenna ports having DMRS tones on combs with a same worst-case distance from the edges of the band are mirror images of each other, and
wherein the means for assigning transmission layers to the plurality of DMRS antenna ports further comprises means for assigning transmission layers to unassigned mirror image DMRS antenna ports in any order.

37. The apparatus of claim 35, wherein the means for assigning the transmission layers to the plurality of DMRS antenna ports comprises:
means for assigning a first transmission layer to a DMRS antenna port for a comb with a smallest worst-case distance from the edges of the band;
means for assigning a second transmission layer to a DMRS antenna port for a comb with a next smallest worst-case distance from the edges of the band; and
means for assigning an n-th transmission layer to a DMRS antenna port for a comb with an n-th smallest worst-case distance from the edges of the band, where n is a number of DMRS antenna ports.

38. The apparatus of claim 37, further comprising means for multiplexing the DMRSs for the antenna ports in a comb fashion, wherein a number of combs is more than 2.

39. The apparatus of claim 37, wherein DMRS tones for each antenna port are uniformly spaced in frequency.

40. The apparatus of claim 31, wherein the DMRSs for the plurality of DMRS antenna ports assigned to the transmission layers are frequency division multiplexed.

41. The apparatus of claim 31, wherein the DMRSs for a first set of the plurality of DMRS antenna ports assigned to the number of transmission layers are frequency division multiplexed; and
the DMRSs for a second set of the plurality of DMRS antenna ports assigned to the number of transmission layers are frequency division multiplexed, and code division multiplexed with the DMRSs for the first set of the plurality of DMRS antenna ports.

42. An apparatus for mapping mobile communication devices to demodulation reference signal (DMRS) antenna ports, the method comprising:
means for determining a number of the mobile communication devices to be assigned to a plurality of DMRS antenna ports;
means for sorting the plurality of DMRS antenna ports in ascending order based on a channel estimation mean square error (MSE);
means for sorting the number of the mobile communication devices in descending order of a downlink (DL) spectral efficiency (SE); and
means for assigning the number of the mobile communication devices to the plurality of DMRS antenna ports in descending order of the DL SE and ascending order of the channel estimation MSE.

43. The apparatus of claim 42, further comprising means for multiplexing the DMRSs for the antenna ports in a comb fashion, wherein a number of combs is more than 2.

44. The apparatus of claim 42, wherein DMRS tones for each of the plurality of DMRS antenna port are uniformly spaced in frequency.

45. The apparatus of claim 42, wherein the means for assigning the number of the mobile communication devices comprises means for assigning a mobile communication device with a highest SE to a DMRS antenna port with a smallest MSE, and a mobile communication device with a lowest SE to a DMRS antenna port with a highest MSE.

46. The apparatus of claim 42, wherein the plurality of the DMRS antenna ports comprises greater than two DMRS antenna ports.

47. The apparatus of claim 42, wherein the channel estimation MSE is highest for DMRS antenna ports for combs having a largest worst-case distance from edges of a band of subcarrier frequencies in a resource block.

48. The apparatus of claim 47, wherein the DMRS antenna ports having DMRS tones on the combs with a same worst-case distance from the edges of the band are mirror images of each other, and
wherein the means for assigning the number of the mobile communication devices to the plurality of the DMRS antenna ports further comprises means for assigning the number of the mobile communication devices to unassigned mirror image DMRS antenna ports in any order.

49. The apparatus of claim 47, wherein a mobile communication device having a higher data throughput has a higher DL SE.

50. The apparatus of claim 49, wherein the means for assigning the number of mobile communication devices to the plurality of DMRS antenna ports comprises:
means for assigning a first mobile communication device having a highest DL SE to a DMRS antenna port for a comb with a smallest worst-case distance from the edges of the band;
means for assigning a second mobile communication device having a next highest DL SE to a DMRS antenna port for a comb with a next smallest worst-case distance from the edges of the band; and
means for assigning an n-th mobile communication device having an n-th highest DL SE to a DMRS antenna port for a comb with an n-th smallest worst-case distance from the edges of the band, where n is a number of the DMRS antenna ports.

51. The apparatus of claim 42, wherein the DMRSs for the DMRS antenna ports assigned to transmission layers transmitted to each of the number of the mobile communication devices are frequency division multiplexed.

52. The apparatus of claim 42, wherein the DMRSs for a first set of the plurality of DMRS antenna ports assigned to transmission layers transmitted to each of the number of the mobile communication devices are frequency division multiplexed; and
the DMRSs for a second set of the plurality of DMRS antenna ports assigned to the transmission layers transmitted to each of the number of the mobile communication devices are frequency division multiplexed, and code division multiplexed with the DMRSs for the first set of the plurality of DMRS antenna ports.
